(19) United States
(12) Patent Application Publication
(10) Pub. No.: US 2014/0172513 A1
(43) Pub. Date: Jun. 19, 2014

(54) ENVIRONMENTAL COMPLIANCE AND MANAGEMENT SYSTEM

(71) Applicant: STANTEC TECHNOLOGY INTERNATIONAL INC., Edmonton (CA)

(72) Inventors: Charles B. MacLean, Calgary (CA); Doug Stewart, Pownal, ME (US)

(73) Assignee: STANTEC TECHNOLOGY INTERNATIONAL INC., Edmonton (CA)

(21) Appl. No.: 13/713,971

(22) Filed: Dec. 13, 2012

(51) Int. Cl. G06Q 30/00

(52) U.S. Cl. CPC G06Q 30/018
USPC 705/7.39

(57) ABSTRACT

A system and method facilitating review, communication and monitoring of regulatory compliance on a utility or project and in particular a computerized, web-based, environmental compliance system (ECS) which monitors, evaluates and displays environmental compliance (or non-compliance) information for any utility or construction project. This includes receiving, storing, communicating and displaying compliance data and information extending over the life of the project from (a) project development phase, through (b) the construction phase, (c) operation phase, and finally (d) project decommissioning phase.

### FIELD OF THE INVENTION

The present disclosure relates to a system and method for facilitating review, communication, management and monitoring of regulatory and cooperative compliance on a project site. In particular the invention relates to a computerized, technological web-based, environmental compliance system (ECS) that enables work teams to project, monitor, evaluate, manage, display and communicate environmental compliance (or non-compliance) information and data for any construction project. This can include receiving, storing, managing, communicating and displaying compliance data and information extending over the life of the project from (a) project development phase, through (b) the construction phase, (c) operation phase, and finally (d) project decommissioning phase.

### BACKGROUND OF THE INVENTION

Generally any development project, and in particular power generation facilities such as wind farms, solar power projects, oil-gas pipeline projects, electrical transmission etc., must comply with complex environmental regulations over the entire life of the facility. Environmental compliance monitoring requires costly time consuming effort which often, in addition to complex scientific and technical monitoring devices, includes field work, i.e. where engineers, biologists and compliance personnel must physically monitor construction sites and collect data in often complex locations and environments. Data collection is merely one step in any environmental compliance strategy. Data should be electronically or physically collected, as well as distributed to all relevant project personnel in a timely and efficient manner. The parties involved in any development project may be for example, the project design engineers, biologists, project field managers, government and independent regulatory offices and personnel, construction personnel, investors, land owners etc. Each of the parties may need direct and immediate access to certain environmental data from the project in order to ensure compliance with regulatory requirements, comply with ongoing compliance procedures, determine compliance events, issue appropriate permits, apply for appropriate permits etc. Much of environmental compliance is based on manual field reporting systems and the preparation and uploading of reports which can be slow and cumbersome and result in significant time delay where the appropriate data and information is not adequately disseminated. Also, current compliance methods and systems are not capable of handling the high volume of data which can be transmitted in many cases by electronic monitoring devices in the field or remote data entry devices used by field monitors. By handling of data is meant the collection, visual display and characterization of the data so that the parties can effectively understand what all the data means relative to previous collected data, the geographic location of the project site, the project timeline and other attributes.

Methods and systems are known for handling specific environmental hazards such as pollution control so that power plant operators and owners can appropriately determine an optimum pollution control strategy for their facilities such as U.S. patent application Ser. No. 10/349,232 to McAllister et al. which describes a method for enabling an entity or a group of entities to comply with a regulation regarding a point-source pollutant. By comparing collected data for the point-source pollution over time with an allowance amount, McAllister et al. describes a method and system to provide an administrator to assess compliance with a regulation between at least two different entities and establish a value for a pollution allowance of the first entity and enabling communication with a second entity also having a determined value to be allocated and finding a mutually agreeable solution enabling the first entity to comply with an environmental regulation.

### SUMMARY OF THE INVENTION

The present embodiment of the ECS facilitates maintaining compliance with overlapping, duplicative, and sometimes conflicting environmental regulations between the various levels of governmental control (local, state, federal). The ECS provides immediate access, and updating, to current information/status/compliance regarding environmental reports, applications, permits, property data and other information for any given project. This access to information within one system provides for better decision making in evaluating development issues in choosing a project site; assists in controlling construction costs based on regulatory requirements, and assists in maintaining compliance standards by documenting, storing and compiling all report information related to the operation of the project. The system also provides a means of standardization (inspection forms/templates, survey forms/templates, etc.) across multiple projects, which eliminates confusion, creates efficiencies and decreases risk.

The ECS can be a server-based technology, meaning the ECS can be hosted on a proprietary server and accessed by authenticated users using web browsers. This system allows the project manager, or administrator, control over the ECS for a client's project and provides specific access levels for various authenticated users. Such a secure proprietary server is beneficial for security and control with respect to access to the server and to data of the ECS project. A desired number of admin users are granted access on the system management/administration side with access rights for the purposes of updating, amending and adding data to the ECS. Data integrity is maintained where generally users from the client's side are granted access only for monitoring data from the ECS for the purpose of understanding and evaluating the various aspects of the environmental information/status/compliance on the project.

The ECS is comprised of a number of configurable components that may be accessible on an easy-to-use dashboard interface. In some embodiments, these components include, for example:
a) Calendar display of critical events and tasks;
b) A key performance indicator (KPI) checklist display which includes task name, scheduled dates for task completion, and a visual color coded status icon, (e.g. red, yellow, green) indicating one of: task completion, task ongoing, or non-completed task, and task completion failure, or overdue. The scheduled dates for task completion are integrated with calendar dates in the Calendar display;
c) A geographic information system (GIS) display that can be a web GIS, which includes a geographic/topographic map services visually showing an overlay of the project data and relevant environmental data integrated into the GIS from the ECS;
d) A documentation library compiling relevant project documents, permits, environmental and otherwise sorted into relevant sub-categories such as “wildlife,” and “natural resources,” and “sound”, etc.;
e) Electronic notification system for generating instant notifications to users regarding changes/modifications, or any relevant environmental (or other) project information immediately to all, or specific users;
f) The electronic notification system also provides a scheduled notification system that generates and distributes emails, text messages and alerts on a scheduled basis in addition to an immediate/on-demand basis;
g) A field data display(s) provides immediate visual access to all uploaded field data as observed by project personnel at the site. The field data, including digital photo and image data, metadata and other attributes, can be provided and uploaded directly from the field via field data collection devices (e.g., data loggers) directly from the location of observed field observation within or surrounding the project site. Any number of different field data survey records may be provided to display desired field data, including “wildlife mortality survey”, another “noise compliance assessments”, etc.

In one embodiment, any desired environmental or other data uploaded from the field (project site) into the field data display(s), or uploaded off-site, is visually overlaid on the GIS display at the appropriate location so that users can scroll on the GIS display and via a related icon on the GIS display, view the associated data stored in the underlying databases and field data displays. For example, an uploaded photo or image data of a deceased avian and other attributes such as GPS location metadata in the image data can be uploaded as a report into the appropriate database directly from the project field/site location along with other relevant information for a “wildlife mortality survey”. The image and other information in the report is saved in the associated database, and the report can be displayed in both a field data table display, and may also be automatically viewed from, for example, a mouse-over link in the GIS display.

The ECS dashboard display may also be customized to be toggled between desired project disciplines such as for example, “wildlife”, “natural resources” and “property owners,” each of which can focus the dashboard display on the particular related data associated with relevant field data displays as well as the GIS overlays for that parameter.

In one aspect, a component of the ECS includes the receiving, storing, organizing, communicating and displaying of all environmental and regulatory compliance data and information extending over the life of the project from (a) project development phase, through (b) the construction phase, (c) operation phase, and finally (d) project decommissioning phase.

In another aspect, the system includes the ability to upload data from remote field locations directly to the ECS for immediate distribution of data and response reducing delays and overall project costs.

In another aspect, the system can control user access using an internet protocol and secure login and passwords.

In another aspect, the system can includes the ability for administrators to control access to data based on types of users and privileges with a limited number of users granted management/administration access for the purposes of system configuration, updating, amending and adding data to the ECS. Other users can be limited, for example, to only viewing privilege access, thereby maintaining system security and data integrity.

In another aspect, the system can provide a status for current regulatory compliance, noting completed tasks, upcoming compliance requirements and out-of-compliance notifications, to properly maintain regulatory compliance status for the lifetime of a project. The ability for regulatory agencies to access and review immediate field results as well as historical data provides for improved negotiations and quicker resolutions to regulatory compliance issues.

In another aspect, the system can generate notification of data and scheduled events and provide it to appropriate user groups for review.

In another aspect, the system can provide analysis and compiling of environmental study data providing for immediate response to issues such as regulatory compliance thereby decreasing project risks and delays.

In another aspect, the system can print, export or mine regulatory and environmental study data using, for example, the complete project documentation library.

In one set of embodiments, this disclosure describes an environmental compliance and communications system capable of streamlining environmental regulation compliance for any phase of a project including development, construction and operation, the compliance and communications system comprising an administrator for maintaining operating system application software installed on a secure server connected to a network interface and applying user access controls for a system user with modifiable access rights to at least one of view, enter and modify data in the compliance and communications system, the application software comprising, at least one database including environmental regulatory requirement data for tracking by the compliance and communications system and a visual key performance checklist which displays at least one of a desired textual or graphical representation of the environmental regulatory requirement data and a status of the project compliance with the regulatory requirement data, a visually displayed timeline separate from the key performance checklist and accessing data from the at least one database including at least one of visual daily, monthly and annual displays associating desired environmental regulatory requirement event data with a particular date, one of the at least one databases including compiled environmental data corresponding to and developed relative to the environmental regulatory requirement data in the at least one database, a documentation library display table to provide access to at least one of documents, studies and reports including certain compiled environmental data, and a geographical information system providing visual geographic map location information corresponding to data from the at least one database.

The system described herein is also directed to a data distribution network for providing information to network users regarding project regulatory compliance, the data distribution network comprising at least a software program installed on a computer within the network, at least one database accessible by the software program, a graphical user interface for displaying and enabling a user to monitor and access data from the at least one database, a remote data upload template permitting remote field data entry including at least one of geographical data and location coordinates into one of the at least one databases, and a geographic information system (GIS) in the graphical user interface visually displaying an associated reference icon linked to the field data entry on a map at a map location corresponding to the at least one of geographical location data and location coordinates from the remote field data entry.

The disclosure is still further directed to a method of providing environmental compliance and communications for streamlining environmental regulation compliance for any phase of a project including development, construction and operation, the method comprising the steps of, maintaining operating system application software installed on a secure server connected to a network interface and applying user access controls for a system user with modifiable access rights to at least one of view, enter and modify data, providing at least one database including environmental regulatory requirement data for tracking environmental compliance and communication linked to a visual key performance checklist displaying at least one of a desired textual or graphical representation of the environmental regulatory requirement data and a status of the project compliance with regulatory requirement data, visually displaying a timeline separate from the key performance checklist and accessing data from the at least one database including at least one of visual daily, monthly and annual displays associating desired environmental regulatory requirement event data with a particular date, providing compiled environmental data corresponding to and developed relative to the environmental regulatory requirement data in the at least one database, displaying a documentation library table providing access to at least one of documents, studies and reports including certain the compiled environmental data, and displaying a geographical information system providing visual geographic map location information corresponding to data from at least one of the first and second

These and other features, advantages and improvements according to this invention will be better understood by reference to the following detailed description and accompanying drawings.

### BRIEF DESCRIPTION OF THE DRAWINGS

Several embodiments of the present invention will now be described by way of example only, with reference to the accompanying drawings in which:

FIG. 1 is a schematic overview of a first embodiment of the environmental compliance system;

FIG. 2 is a schematic diagram of a computer system for the first embodiment of the environmental compliance system;

FIG. 3 is a diagrammatic view of a first embodiment of an environmental compliance system network;

FIG. 4 is an embodiment of a project list display of a first embodiment of an environmental compliance system;

FIG. 5 is an embodiment of configuration of notification settings of a first embodiment of a environmental compliance system;

FIG. 6 is an embodiment of a dashboard of a first embodiment of an environmental compliance system;

FIG. 7 is an embodiment of an integrated calendar and performance checklist of a first embodiment of an environmental compliance system;

FIG. 8 is an embodiment of a documentation library of an environmental compliance system;

FIG. 9 is a flow chart illustrating an embodiment of a process for integrating the calendar and performance checklist of an environmental compliance system;

FIG. 10 is an embodiment of wildlife database information of a first embodiment of an environmental compliance system;

FIG. 11 is an embodiment of a geographical information system displaying wildlife survey information in a first embodiment of an environmental compliance system;

FIG. 12 is an embodiment of a geographical information system displaying area information in a first embodiment of an environmental compliance system;

FIG. 13 is an embodiment of a geographical information system displaying distance information in a first embodiment of an environmental compliance system;

FIG. 14 is an embodiment of wildlife incidental observation and mortality survey tables in a first embodiment of an environmental compliance system;

FIG. 15 is a flow chart illustrating an embodiment of report access in an environmental compliance system;

FIG. 16 is an embodiment of the integration of the field data with the GIS in an environmental compliance system;

FIG. 17 is a further embodiment of wildlife database information in an environmental compliance system;

FIG. 18 is an embodiment of natural resource database information in a first embodiment of an environmental compliance system;

FIG. 19 is an embodiment of Spill Prevention, Control and Countermeasure (SPCC) database information in a first embodiment of an environmental compliance system;

FIG. 20 is an embodiment of permit database information in a first embodiment of an environmental compliance system;

FIG. 21 is an embodiment of cultural resource database information in a first embodiment of an environmental compliance system;

FIG. 22 is an embodiment of regulatory communications database information in a first embodiment of an environmental compliance system;

FIG. 23 is an embodiment of a process of notification of an incidental observation in a first embodiment of an environmental compliance system;

FIG. 24 is an embodiment of an electronic messaging system in an environmental compliance system;

FIG. 25 is an embodiment illustrating a property owner's database information in an environmental compliance system; and

FIG. 26 is an embodiment illustrating access to a zoning map in a first embodiment of an environmental compliance system.

### DETAILED DESCRIPTION OF THE INVENTION

Described herein is an environmental compliance systems that can provide instant access to pertinent stored and real-time current data throughout the lifetime of a project to both internal and external entities based on each entity's requirements and responsibilities. The system described herein also allows data to be evaluated and reacted to in a timely manner to minimize project non-compliance, limit delays and/or shutdowns, and reduce overall project costs. A user of the system can use the graphical and textual information provided by the system to make decisions regarding construction and compliance with environmental regulations. Thus, the environmental compliance system can bring information and data to decision makers in the field that was not previously available to them.

The environmental compliance system, sometimes referred to throughout the following specification as “ECS” has a general reference number 35, provides from a general overview perspective, an efficient and streamlined data handling and dissemination structure including organizational and integrated linkages of data which provide multiple users with critical data and information within one system allowing the user to more clearly understand and access the complex inter-relationships of data, and to track project revisions in real time.

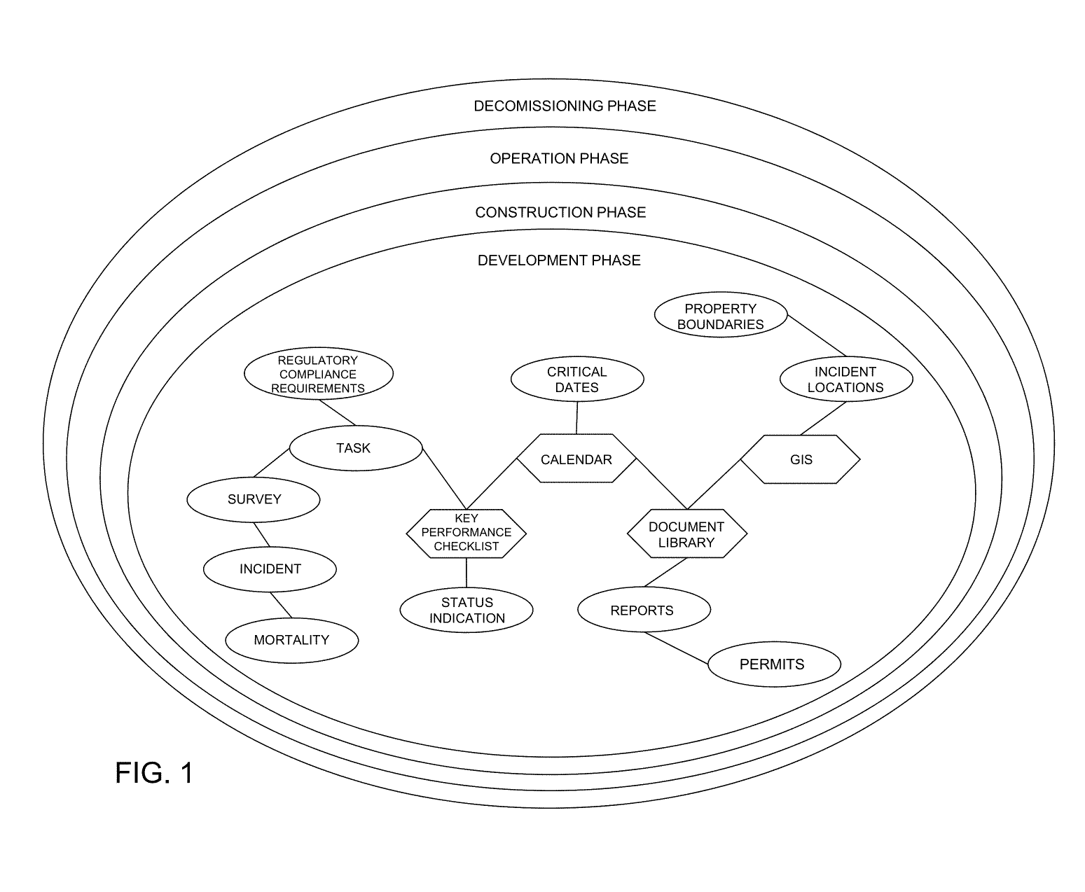

Important to the present invention, as shown in FIG. 1 and described in further detail below, field survey data, task information, performance checklist, a timeline or calendar, a document library and a geographical information system (“GIS”) are integrated together and informationally linked and visually displayed to system users to present a comprehensive visual informational picture of environmental compliance for any project. The survey data is generally input to the ECS as a survey record by field personnel and includes incidental observation data as well as specific required data, for example wildlife mortality survey data. Task data is similarly input into the ECS more generally from system administrators or perhaps regulatory entities and both the survey record and task data are integrated and shared as necessary with the performance checklist and calendar. Further, important documents such as reports and permits which might include various versions and updates and include task and survey data can be stored and organized in a documentation library, with all of these features, data and information being additionally integrated and shared with the GIS. This organizational structure and integrated linkage of data is stored and provided to multiple users through all phases of a project, development phase, construction phase, operational phase and even decommissioning phase so that the critical project information base is maintained and available to users of the ECS throughout the life of a project.

In the following description, some features are described as “software” or “software programs”. Those skilled in the art will recognize that the equivalent of such software can also often be constructed in hardware. Because data manipulation algorithms and systems are well known, the present description emphasizes algorithms and features forming part of, or cooperating more directly with, the method and hardware of the presently disclosed invention. General features of databases, digital communications devices, email and computerized systems are likewise well known, and the present description is generally limited to those aspects directly related to the method and related hardware of the invention. Other aspects of such algorithms, apparatuses, hardware and/or software for producing and otherwise processing the data involved therewith, not specifically shown or described herein, may be selected from such systems, algorithms, components, and elements known in the art.

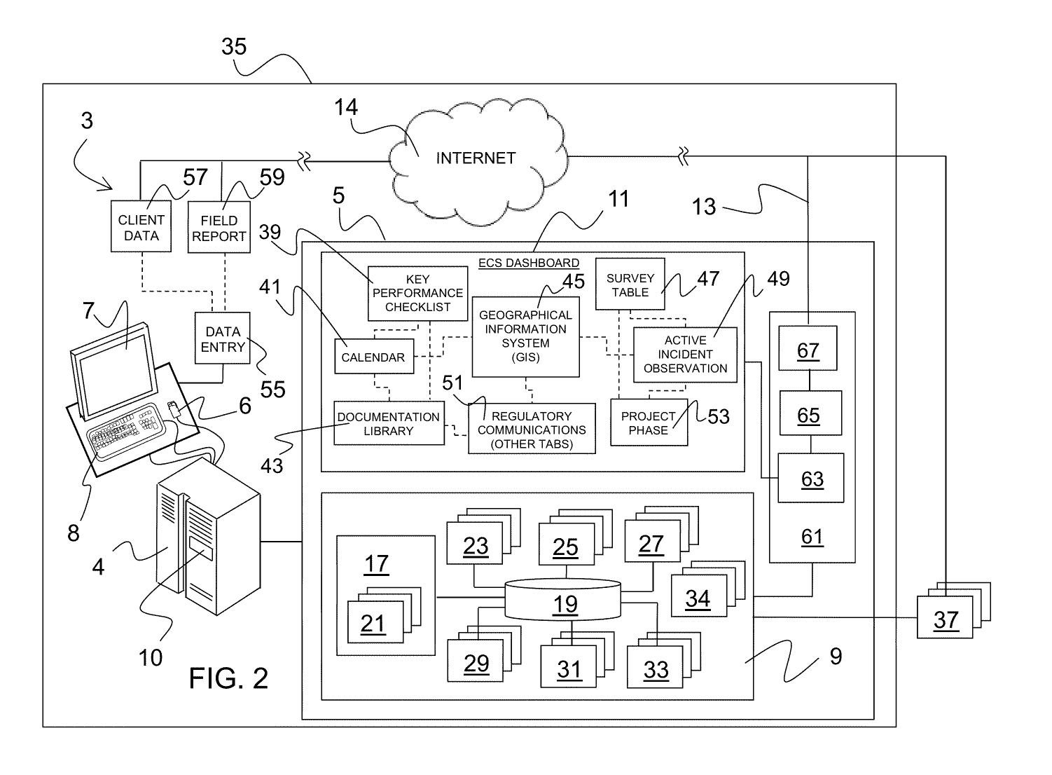

The present invention can be implemented in computer hardware and computerized equipment. For example, the method can be performed using a system including one or more digital communications devices and/or one or more personal computers. Referring to FIG. 2, there is illustrated a computer system 3 for implementing the present invention. Although the computer system 3 is shown for the purpose of illustrating a preferred embodiment, the present invention is not limited to the computer system 3 shown, but may be used with any electronic data processing system such as found in personal or other digital communications devices, cellular phones and other mobile devices, home computers, tablet computers, or any other system for the processing of digital data. The computer system 3 includes a server computer 4 having a microprocessor-based unit 5 (also referred to herein as a processor) for receiving and processing software programs and for performing other processing functions. An output device 7 such as a visual display is electrically connected to the processor unit 5 for displaying user-related information associated with the software, e.g., by means of a graphical user interface. A keyboard 8 may also be connected to the processor unit 5 for permitting a user to input information to a software program. As an alternative to using the keyboard 8 for input, a mouse 6 may be used for moving a selector on the display 7 and graphical user interface, or alternatively a touch screen input device may be provided for selecting an item and providing input to the processor 5. It is to be appreciated that the input is not limited to the known input apparatus and methods but includes input methods and devices which may yet be developed.

Memory, in any form, can be included and is illustrated as a hard-disk device such as computer readable storage medium 9 or compact disk-read only memory (CD-ROM) 10, which can include software programs, is inserted into the microprocessor based unit 5 for providing a means of inputting the software programs and other information to the microprocessor based unit 5. Multiple types of memory can also be provided and data can be written to any suitable type of memory. Memory can be external and accessible using a wired or wireless connection, either directly or via a local or large area network, such as the Internet. Still further, the processor unit 5 may be programmed, as is well known in the art, for storing the software program internally. A printer or other output device can also be connected to the processor unit 5 for printing a hardcopy of the output from the computer system. The processor unit 5 can have a network connection 13, such as a telephone line, network cable or wireless link, to an external network, such as a local area network or the Internet 14.

The output device 7 provides visually to the user transactional, interactive or variable data that has been subject to transformations. The output device 7 can be a monitor or other visual computer screen or graphical user interface (GUI) a printer or other output device that provides a visual or other representation of a final output from the processor unit 5. The output device 7 can also be an output device that provides the transactional data as a digital file.

The processor unit 5 provides means for processing the transactional, interactive or variable data to produce readily discernable, informational and organized images and data on the intended output device or media. The present invention can be used with a variety of output devices that can include, but are not limited to, a digital photographic printer and soft copy display. Those skilled in the art will recognize that the present invention is not limited to just these mentioned data processing functions.

The server computer 4 shown in FIG. 2 can store a computer program product having a program stored in the computer readable storage medium 9, which may include, for example: magnetic storage media such as a magnetic disk (such as a floppy disk) or magnetic tape; optical storage media such as an optical disc, optical tape, or machine readable bar code; solid state electronic storage devices such as random access memory (RAM), read only memory (ROM) or flash memory data storage devices. The associated computer program can also be stored on any other physical device or medium employed to store a computer program indicated by offline memory device.

It should also be noted that the present invention can be implemented in a combination of software and/or hardware and is not limited to devices which are physically connected and/or located within the same physical location. One or more of the devices illustrated in FIG. 2 can be located remotely and can be connected via a network. One or more of the devices can be connected wirelessly, such as by a cellular link, either directly or via a network. It is to be appreciated that such devices can be mobile devices (e.g., camera, PDA, iPod, iPad, tablet computer or cell phone that can be used as a processing unit, a display unit, or a unit to give processing instructions), and as a service offered via the World Wide Web.

In each context, the invention may stand alone or may be a component of a larger system solution. Furthermore, human interfaces, e.g., the input, the digital processing, the display to a user (if needed), the input of user requests or processing instructions (if needed) and the output, can each be on the same or different devices and physical locations, and communication between the devices and locations can be via public or private network connections, or media based communication. Where consistent with the foregoing disclosure of the present invention, the method of the invention can be fully automatic, may have user input (be fully or partially manual), may have user or operator review to accept/reject the result, or may be assisted by data or metadata (data or metadata that may be user supplied, supplied by another computer program or database from a different application or determined by an algorithm). Moreover, the algorithm(s) may interface with a variety of workflow user interface schemes.

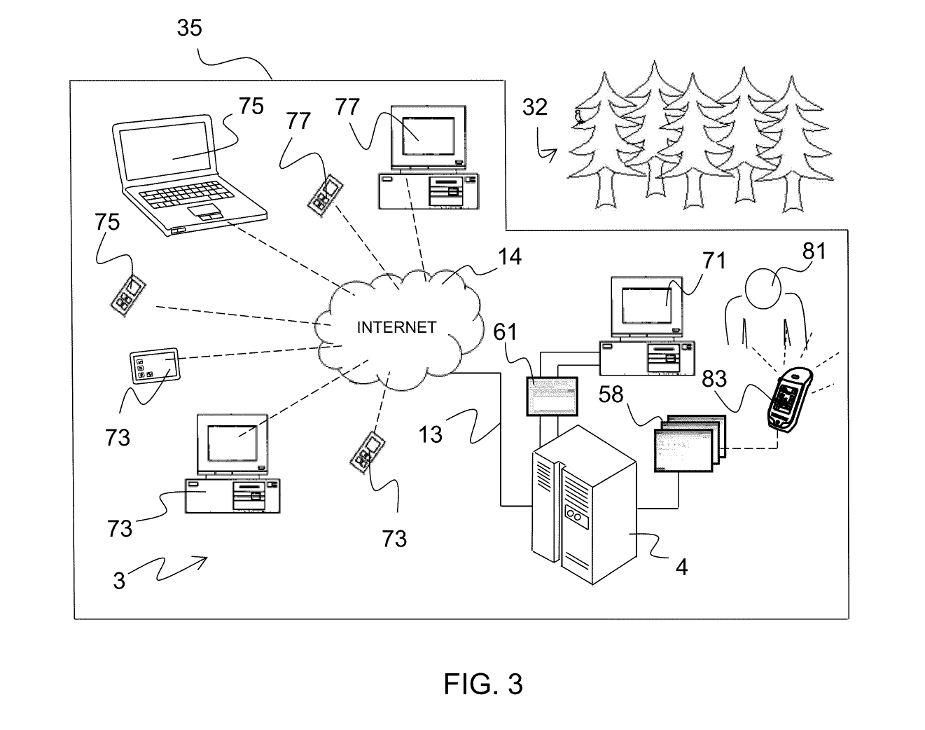

In a first embodiment as shown in FIGS. 2 and 3, the ECS, indicated diagrammatically as 35, would include the above described computer system 3, application software 17, one or more database tables 19 including for example a user contact information database 21 document history database 23, field survey/reports library and database 25, natural resource 27, a cultural resource database 29, government permit database 31, a regulatory communications database 33, and a Spill Prevention, Control and Countermeasure (SPCC) database 34 to configure the ECS as an example for the construction phase of the project to appropriately track compliance based on specific project conditions and regulatory requirements. By database is meant any type of organized collection of data in any form including tabulated, document-text, statistical, spreadsheet, bibliographic, etc. and data organized in any manner in which the processing of the data is facilitated in the ECS. The ECS 35 described herein is not limited to these databases; other databases may be included for certain other phases of the project. Databases for environmental assessment, sound compliance or property ownership may be appropriate during the development phase and further databases such as easement/leases and vegetation management may be appropriate during the operation phase. Access to external data records and/or databases 37, for example governmental regulatory information may also be provided. User logins and preferences would link specific user information to their user identification to provide predetermined access to information for each user. Administrative tools within the application software 17 would monitor, add or remove users, manage content and set restrictive/predetermined access to users of the ECS 35. The system further includes a notification generator 61 that will be described in more detail below.

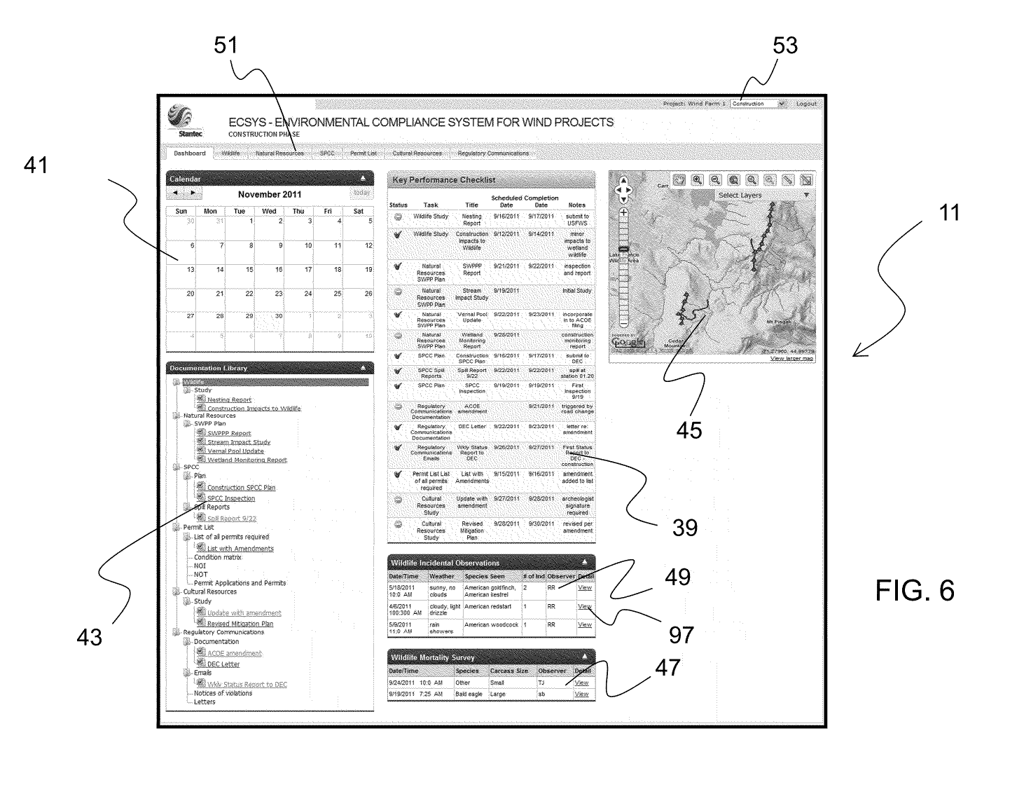

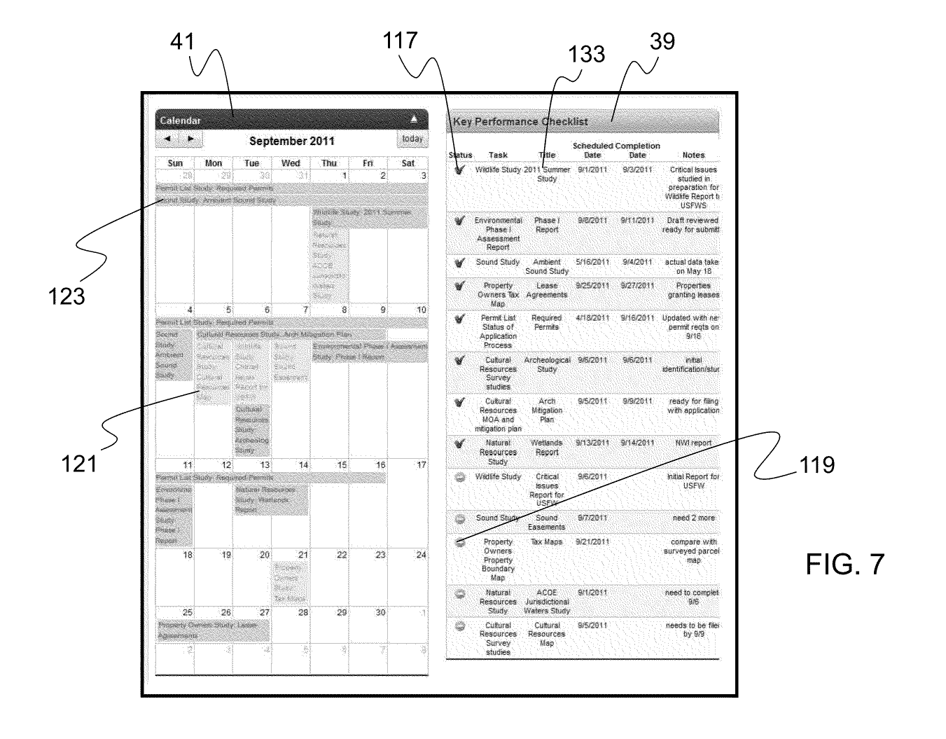

The ECS dashboard 11 as shown diagrammatically in FIG. 2 provides immediate access to integrated real-time information about and during all phases of the project. A general description of the dashboard 11 includes the key performance indicator (KPI) checklist 39 which displays pending and completed compliance tasks with visual color coded status indicators. The tasks can be integrated to the calendar display 41 to allow a user to easily determine when and if regulatory requirements are due, overdue, pending, or have been met. A non-compliant status indicator exists to quickly address any issues and move the project forward. The tasks and status indicators are not shown in FIG. 2, but are shown and further discussed in detail below with reference to FIGS. 6 and 7.

The dashboard 11 also includes a documentation library 43 which can provide access to all current, pending or completed reports and requirements from any part of the development, construction or operational phase of the project. An active incidental observation table 49 provides data from an incidental observation survey and the data can be integrated directly with the GIS 45 to display the specific location where an incidental observation has occurred. Incidental observation data can be compiled from a report format and presented to a viewer within the active incidental observation table 49, a further description of the report and active incidental observation table 49 is provided below.

Besides the dashboard 11 additional tabs 51 can be provided to access, for example, pages with more detailed content. For example, such tabs or modules could include regulatory communications data, correspondence, natural resources data, permit information and cultural study data. These are examples of typical modules that may be used, however the system is not limited to these examples. Organizational structure of the system may be tailored for each client to accommodate that client's own jurisdiction and nomenclature deemed most effective. A project phase 53 toggle on the dash board 11 allows selection of phase-specific information to be displayed on the dashboard 11 from development through decommissioning of the project with every report and environmental study from any timeframe being accessible.

The ECS 35 embodied within the above described computer system 3 shown in FIGS. 2 and 3, is a valuable benefit to utility companies, construction companies, transportations companies, regulatory compliance agencies and others. An important aspect of the present invention is an improvement in the efficiency of communication between entities involved in the development, construction and operations of a project and/or facility. Through the computerized ECS 35 shown in FIG. 3, an efficient communications network is developed, the network itself being represented by the different entities or clients 73 having computers, laptops, PDA's, iPods, iPad, tablets, cell phones, and other digital media communication devices, with record(s) of the environmental data maintained through the active database management handling the data. The data includes but is not limited to regulatory requirements, schedules, survey reports, property information and transactional data, permits and geographical data, and other information. Most importantly, the system provides a means by which to organize and distribute data efficiently, integrate data with project timelines, and present data in accessible visual formats.

Administrative permissions may be set up to allow only the internal data managers 71 (or other designees) to configure system parameters and to update, amend and add data. Internal data managers 71 could also have remote access via the internet, however access to data is controlled to allow clients 73 and other various entities such as project management personnel 75 and regulatory agency personnel 77 to monitor all or only part of the data based on the entity's requirements and responsibilities. In some embodiments, administrative permission can allow for data entry and upload of surveys and reports for example. Field survey data may be remotely uploaded to the system by field surveyors and researchers 81 using remote data transmitters 83 and by selecting the appropriate data form template 58. The data form template 58 provides data entry fields that are configured specifically for the type of data that is entered and with the proper industry and client specific terminology. In this way data is properly annotated and organized with the ECS databases and prepared for extraction to various visual displays of the system. Although the term “survey” and “report” may be used interchangeably, it is to be appreciated that data collected directly at a project site is most often referred to as survey data, and documents and compilations of survey data are generally denoted as reports. In either event, this data is not only uploaded and available to the respective system users, but may also be immediately distributed using the notification generator 61 also known as the on-demand email messaging process. Notified users may be allowed access to all current and historical data to best evaluate project conditions to determine and communicate quickly the most appropriate course of action to correct and maintain compliance and reduce project delays or shutdowns.

The installation of the ECS 35 on a server 4 connected to the internet 14 provides a platform for any number of entities to have access to the ECS 35. In general, to use the system at any time an entity of the ECS 35, such as a client, regulatory authority, or project manager for example, must enter a secure user name and password on a login screen to enter the system. Since such login screens and access methods can be done in a variety of ways to secure the system 35, no further description is provided in this regard. As discussed above, this access may provide only the ability to review data with no access to enter, manipulate or delete data, thereby maintaining data integrity.

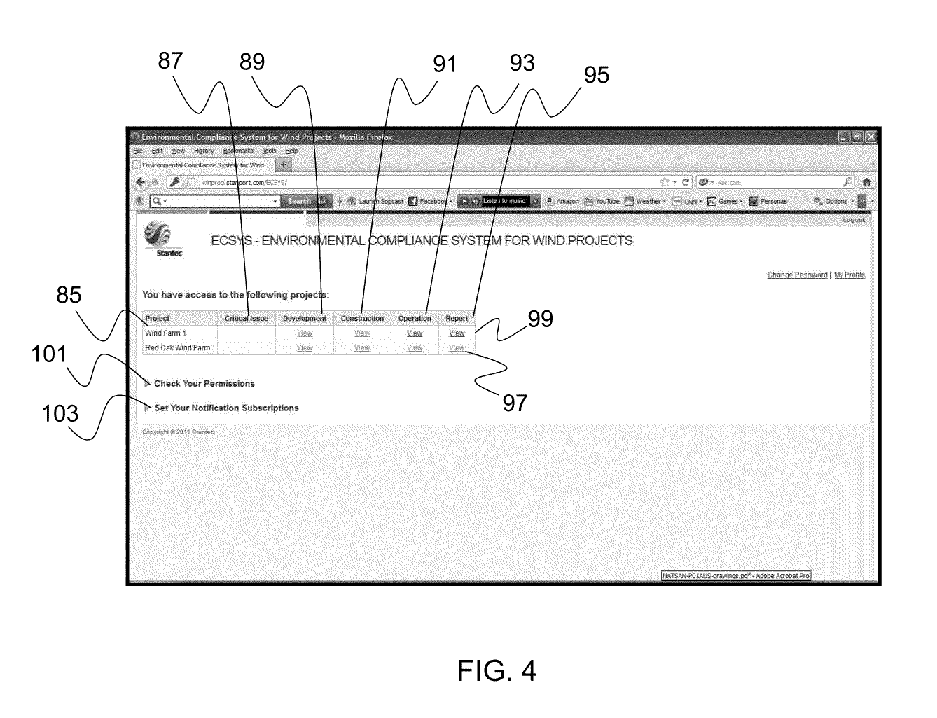

Upon entering the system, an interface screen can provide a list of projects 85 in a project table 99 accessible to the user as shown for example in FIG. 4. A client may have one or more projects on going and in various phases, or have plants in operation in locations throughout the world and access to all current and historical data of each site is readily available. Access control to critical issues 87, to each phase, development 89, construction 91 and operation 93, and to surveys 95 is shown with a view option 97 within the project table 99 in FIG. 4. Permission control settings 101 for each project may be viewed and requests for modifications to access can be sent to database management administrators 71 as required.

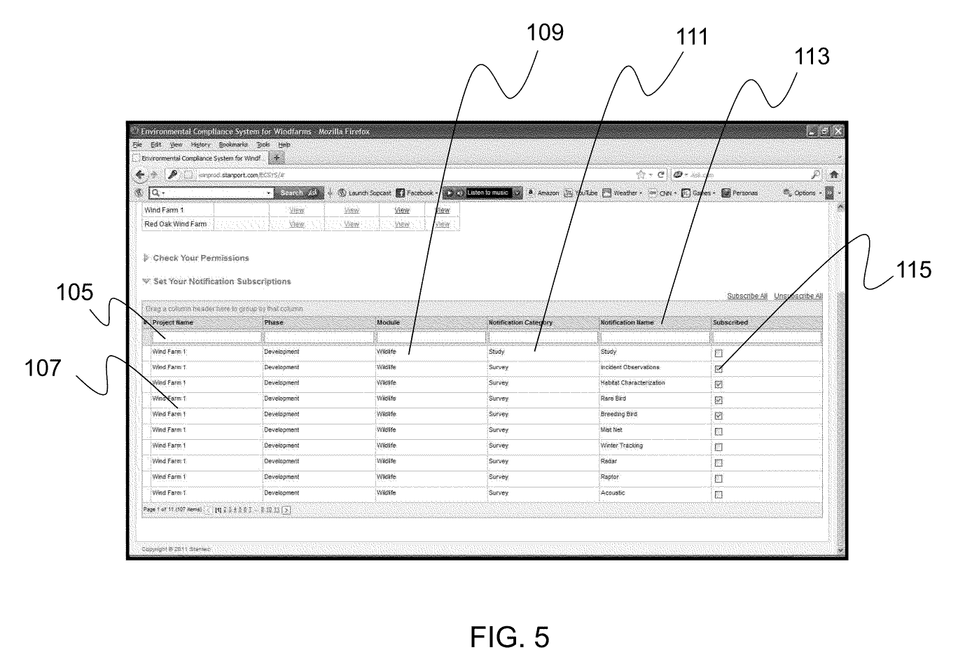

As noted above, system 35 provides along with the initial project selection table 99 the important aspect of allowing the user to set what communications and notifications they want to get immediately, thus almost instantaneously disseminating important information via communication notifications to appropriate users of the system 35. Preference for such notifications can be selected by the user through the notification subscription settings 103 shown in FIG. 5. An input box 105 allows a user to enter, choose or sort for a specific project name 107, phase, module 109 and notification category 111 i.e. surveys or reports for example and the subcategories include a list of notification names 113, for each project. A user can select the subscription check box 115 for one or more notifications or communications relating to the chosen notification categories 111 and notification names 113, and they are added to the notification list for any entry, schedule or change made to field surveys, documents or reports. For example, a project manager for the client may select incidental observation notification in order to be notified of any incidental observations of wildlife mortality, and therefore be able to evaluate and respond to any incidental observation in a timely manner.

By selecting a view option 97 from the project list 85 of FIG. 4 the user opens the ECS and the dashboard 11 is displayed. The dashboard 11 provides a visual overview of data available within the project. The dashboard 11 may include but is not limited to a calendar 41, key performance checklist 39, a documentation library 43, an incidental observation table 49, a survey table 47 and a GIS 45 to visually display project information as shown in FIG. 6. The phase of the project with all information and data related to that phase may be selected for display from the phase menu 53.

The calendar 41 is integrated with the KPI checklist 39 that displays selected Reports and Studies that may be completed, on-going and planned for each phase of the project as shown in FIG. 7. The integrated link shows updates and timeframes of the project on both the calendar 41 and the checklist 39 with icons and color codes that indicate actions that have been completed or are in compliance. For instance, completed actions may be marked with, for example, a green check mark 117. Pending or incomplete matters may be marked by a dashed circle in yellow 119. This same indicator may be used for a matter in need of attention, depending on the context of the document or date in questions and therefore action must be taken. The checklist 39 is not limited to these described graphical status indicators and other such icons or symbols may be used to immediately discern status of any task on the checklist 39. Each block of the calendar may be similarly colored on specific dates of scheduled, on-going 121 and completed tasks 123. By selecting the calendar date the appropriately dated key performance checklist is displayed.

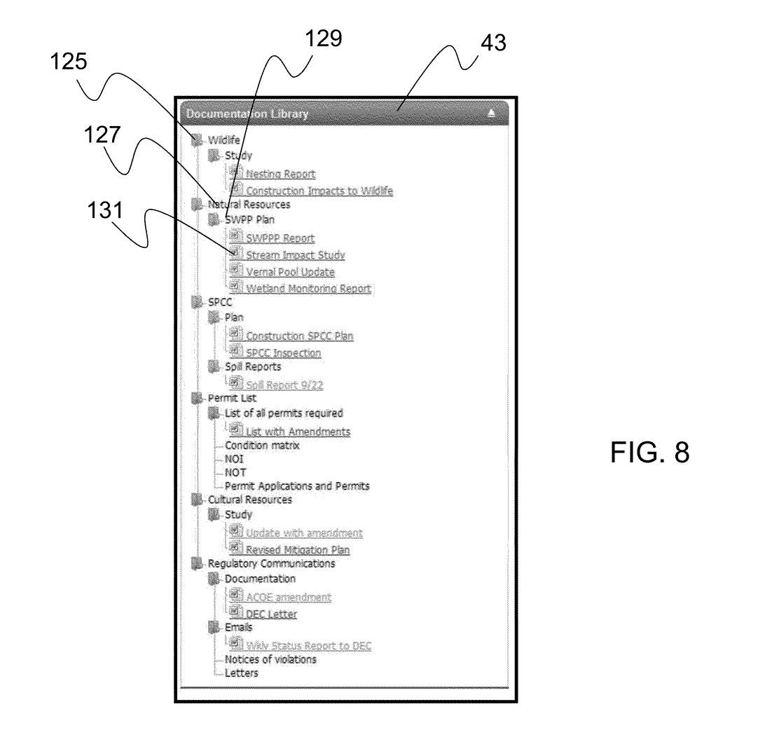

The documentation library 43 as shown in FIG. 8 provides a documentation tree 125 that lists each category 127 of the project, each sub-category 129, and each file 131, i.e. document, graphics or other type of file 131. By selecting file, the file opens in the appropriate format for review. All historical and current documents of the project that are loaded into the system are therefore accessible to users of the ECS. The documentation library 43 is also integrated with the performance checklist 39 so that when a title of a study 133 is selected from a task of the performance checklist the document is extracted from the documentation library 43 and opens.

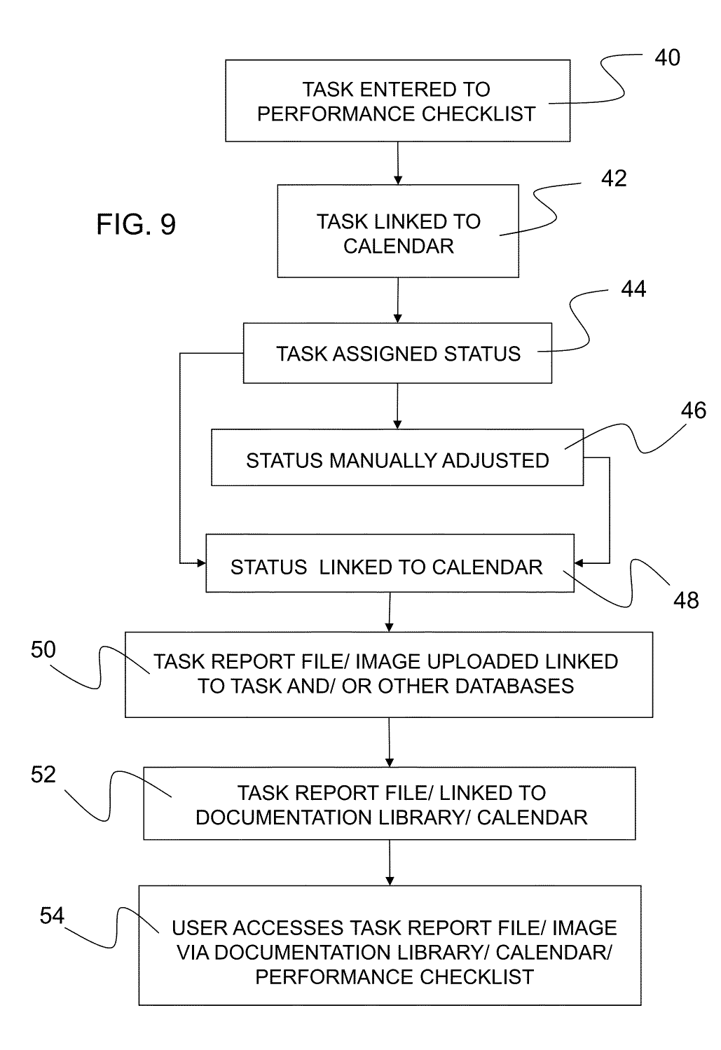

Turning to FIG. 9, a step-wise process for integrating the calendar and performance checklist is described starting with a task entered into the performance checklist at step 40 with an associated date or dates for completions in a specific task entry input screen (not shown). The task is linked at step 42 to the calendar by the respective dates and the task is assigned a status at step 44 either automatically at step 44, or manually at step 46. The status of the task is then also integrated with the calendar at step 48. A file such as a document or image file may be uploaded at step 50 and associated with the task and linked to other report databases and tables or to the document library at step 52. With the integration of this information and data in the ECS system between the various components of the ECS, a user of the ECS may for example access the task file itself via the calendar, performance checklist or the document library as shown in step 54.

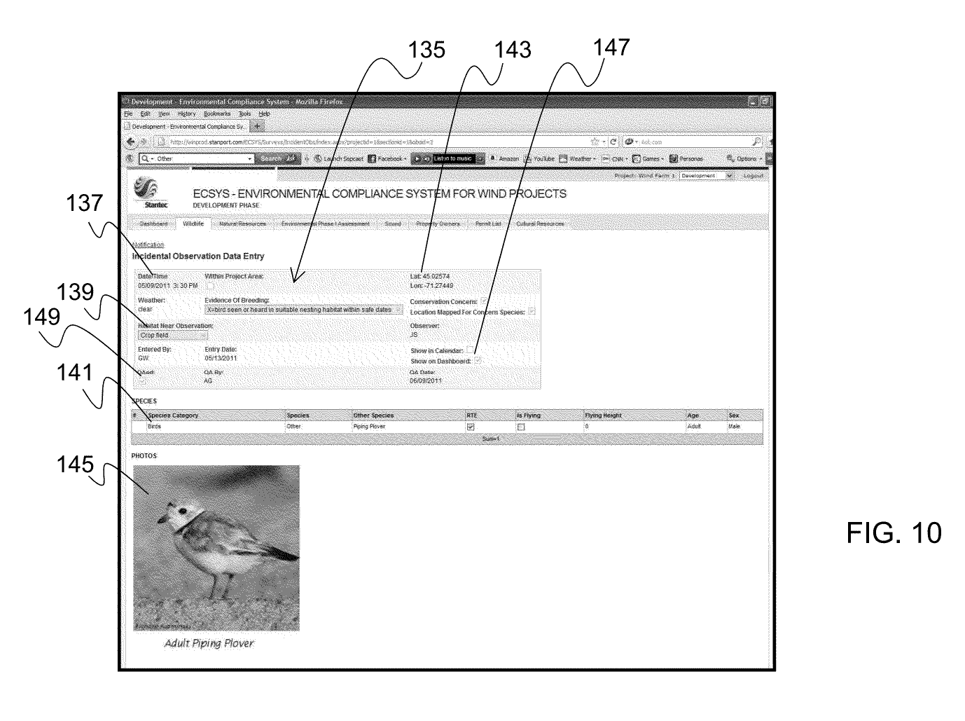

The incidental observation data table 49 on the dashboard 11 provides survey records of specific environmental incidents from on-going environmental surveys. Specific details of the survey record are displayed by selecting the view indicator 97. As an example, as shown in FIG. 10, an incidental observation survey record 135 showing evidence of breeding of a protected bird species is shown. The data fields including date and time 137, the habitat 139, species 141, and geographical coordinate location 143 of the incidental observation provide a means with which to enter appropriate data. Photos 145 of the wildlife found or other information may be displayed or attached. Photos of animal species or other explanatory photos may be selected from a previously compiled database or may also be real time photos uploaded from the field and/or the site of the observation. The observation may be displayed on the calendar 41 or dashboard 11 by selecting the appropriate check box 147. The time period for display may be set by, for example, the content editor or the system administrator to limit information displayed on the dashboard to the most recent, most critical or other display criteria for each event. Additional information for the time of data entry and an indication that the information has been verified and approved for distribution may be noted by entering the reviewer and checking the quality assurance check box 149.

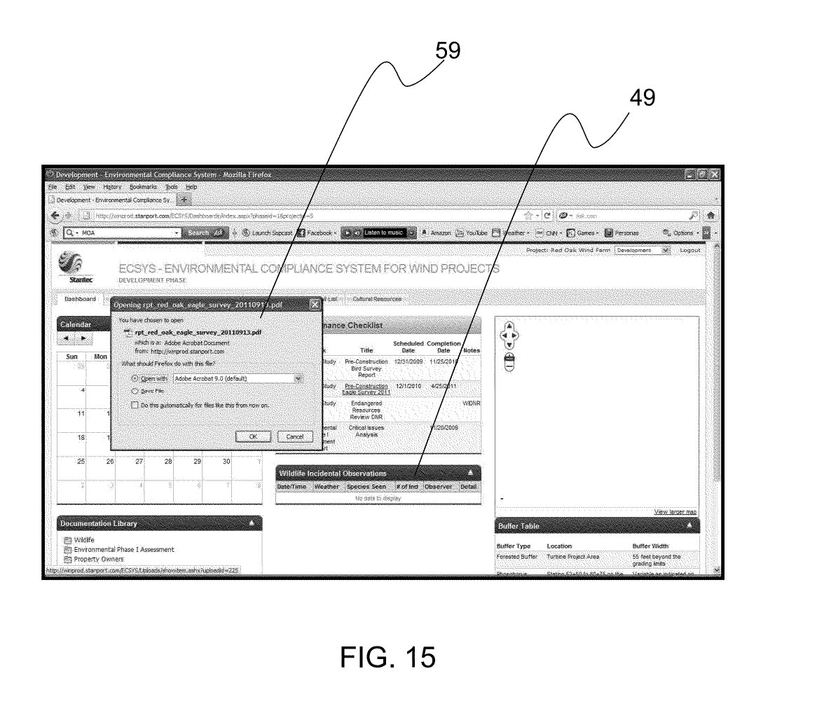

This system of data entry, display and verification is applicable to other surveys and data entry fields such as data for the mortality survey and report processes elsewhere in the system. The ECS may contain any number of predefined survey and report forms and templates which facilitate the remote entry of data from the field. As shown diagrammatically in FIG. 15, a project manager, or other field personnel may enter the ECS system and, for example, from the field survey/reports database 25 retrieve a predefined survey form (such as an incidental observation, or wildlife mortality survey form or template) including specific data entry fields. Once these appropriate data fields are completed in the selected survey form, the survey form may be immediately uploaded to the ECS as a survey record and the survey record or a message denoting the survey record can be distributed to specific ECS users and administrators through the on-demand messaging process.

It is to be appreciated that the uploading of a real time incidental photo or digital image as or with a survey record may provide other incidental digital data, metadata and other attribute data which can be incorporated and integrated into the ECS. For example many digital images include metadata which can include the geographical location such as GPS data, date and time, the photographer's name and the type and specific camera the image came from. In some embodiments, metadata such as a description may be added to the digital image at a later time. For instance, a description of the image contents and context for use in the ECS may be associated with the image file. For example in one embodiment of the present invention, the field camera which takes the digital image of the real-time incidental observation also applies the GPS and time and date data to the digital image. When the digital image is uploaded to the system this metadata from the image is extracted from the image and integrated into the incidental observation survey via the GPS unit.

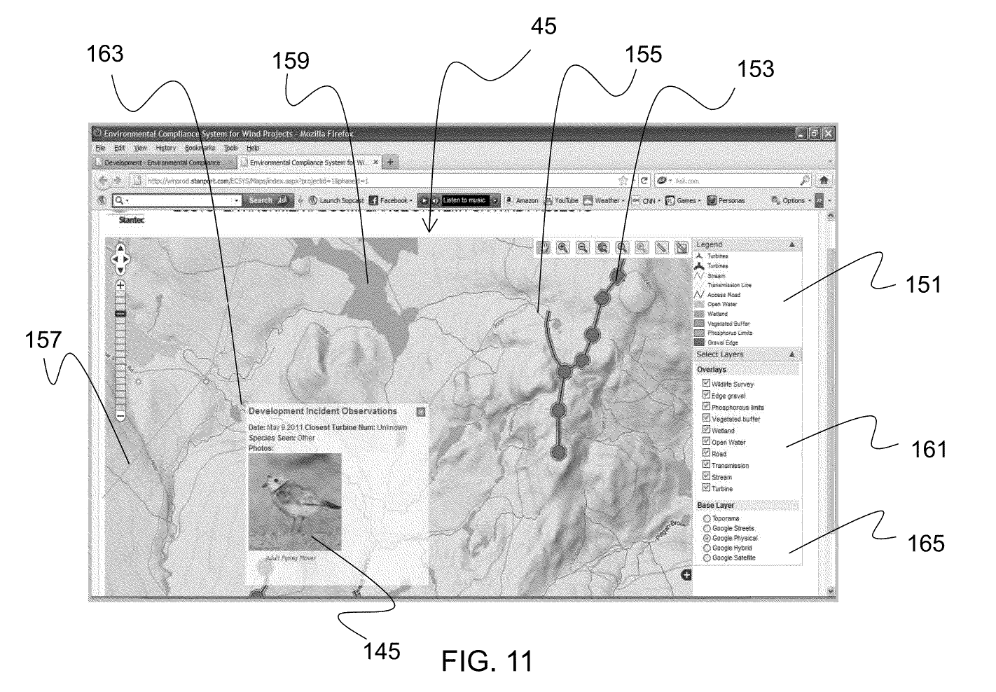

The incidental observation data, attribute data and even the metadata as described above, may be manually or automatically extracted to the geographical information system (GIS) 45 from the data fields for latitude and longitude 143 available from the incidental observation forms of any survey record. As shown in FIG. 11, the geographical information system 45 uses a visually displayed geographical mapping program or application to display critical map features and location information related to the project and the surrounding area. A legend 151 provides a key to features that may be displayed on the map, such as the plant facility 153, access roads, 155 transmission lines 157, wetlands 159, etc. The overlay selector 161 allows these desired features to be displayed by selecting the appropriate check box. Additionally the overlay selector allows wildlife survey records to be displayed. An incidental observation indicator 163 such as an outlined circle depicts locations where sightings of wildlife related to an environmental study have been observed. By hovering the mouse over the incidental observation indicator 163 the details of the sighting are displayed including any digital image 145 that has been uploaded with the data. The integration of the field incidental observation survey record with the GIS allows environmental regulatory compliance personnel and others to view the incidental observation sightings in context to their relationship to one another and in relationship to the facility and other geographical features within the geographical region of the project site in order to assist in determining a proper course of action based on sightings and incidental observation survey record.

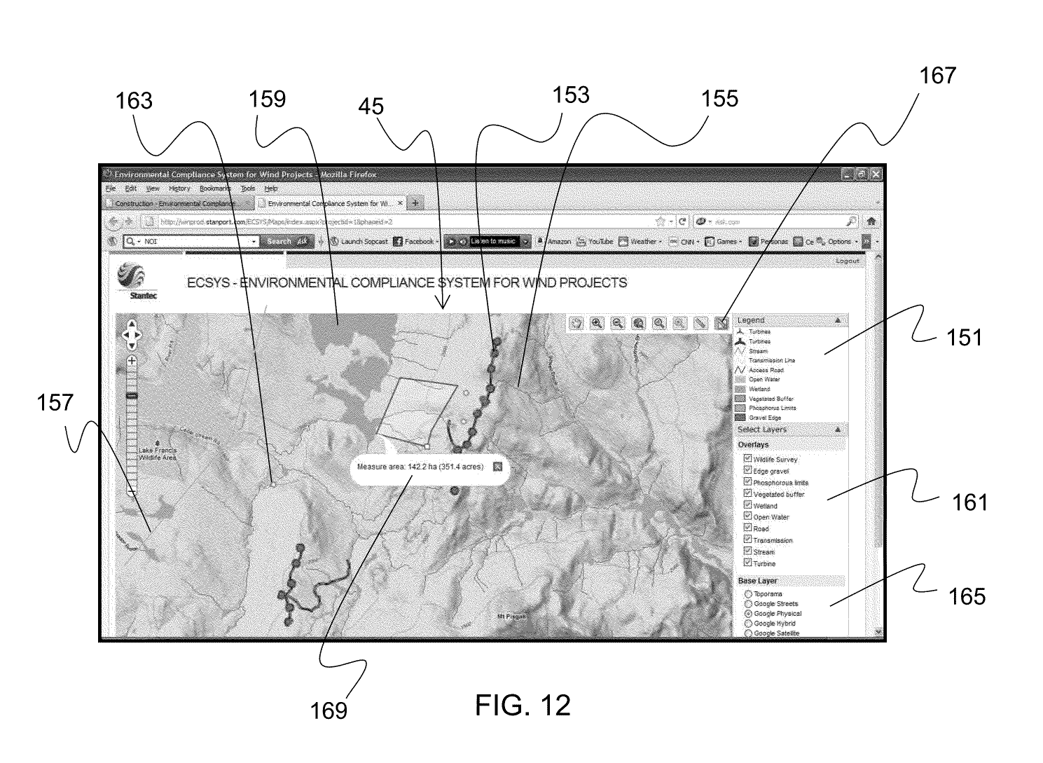

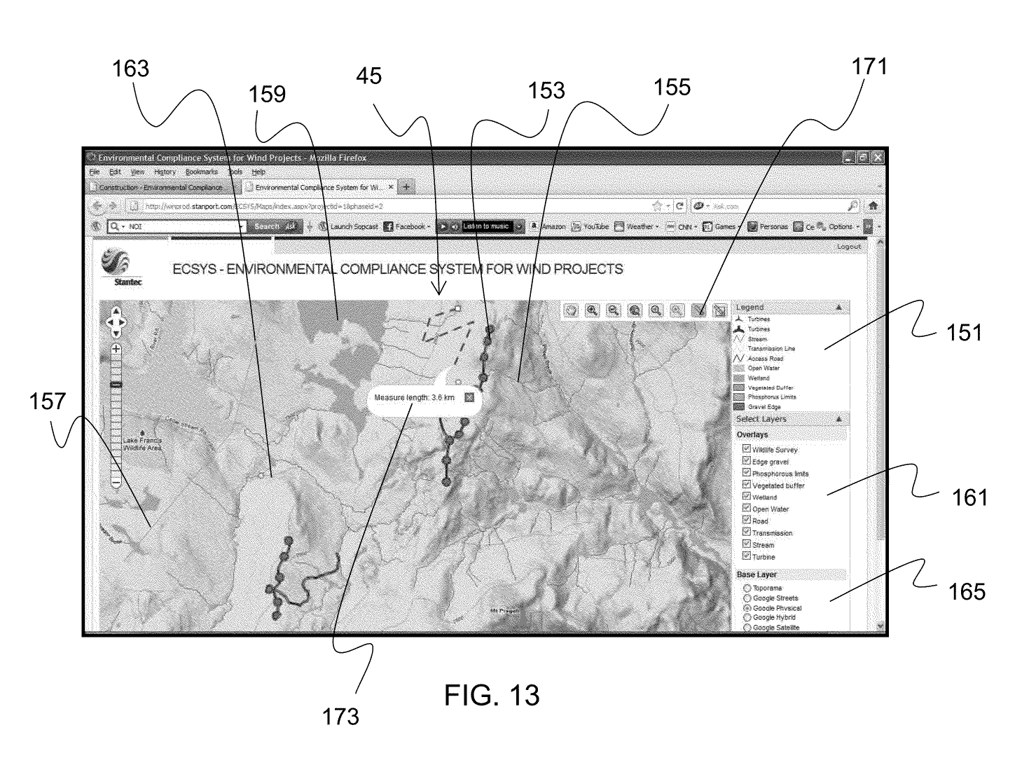

In one embodiment, the GIS also provides options for viewing different base mapping web services including by selection of an option from the base layer viewer 165 to display, topographical features, road network or satellite images, etc. The GIS also provides for area and distance values to be measured by selecting either the area icon 167 and scrolling across a region of the map, a two dimensional highlighted overlay appears over an area of the map and the area measurement in hectares and/or acres 169 is displayed, or by selecting the distance icon 171, a linear overlay appears over the map 173 showing the distance from one point on the map to another as shown in FIGS. 12 and 13.

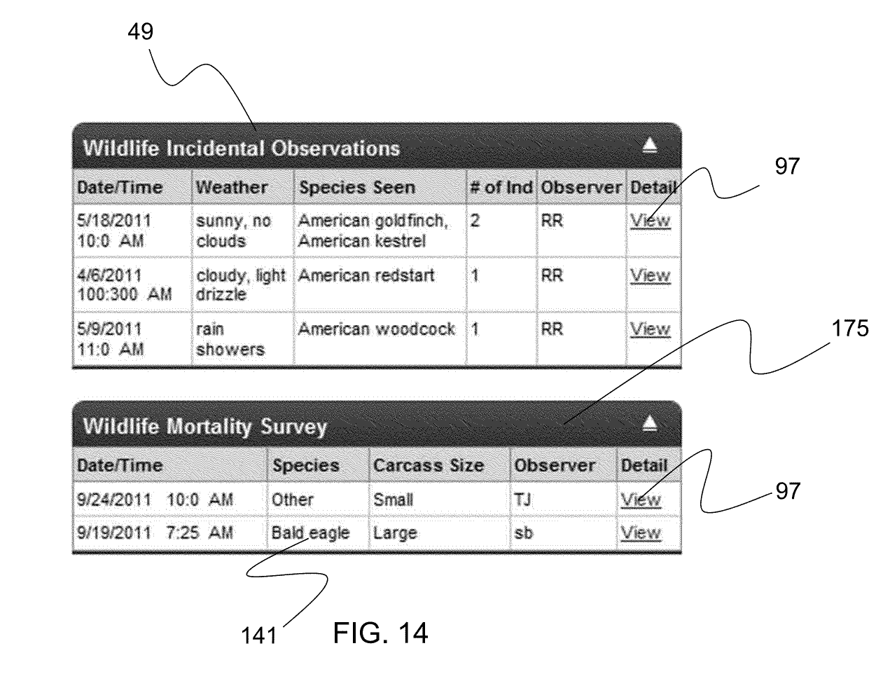

In addition to the incidental observation table 49, other important data may be displayed on the dashboard 11 by selecting the option for display 147 on the data entry screen. For example, an on-going survey status table may display data from a wildlife mortality survey 175 on the dashboard 11. The data may include the species information 141, location and a view option 97 to access the field survey record 59 or additional documents and data such as location data related to the mortality survey as shown in FIG. 14. The data may then also be integrated and displayed on the GIS 45 to provide accurate incidental observation location information to allow for a comparative analysis of related incidents.

By scrolling over the data table, each observation, incidental observation or survey record can be highlighted and the GIS can adjust to the proper location to display an indicator showing the location of the incident. Color coded icons and symbol indicators may be used to designate data from different survey information, for example larger dark colored circles may denote mortality data, while smaller light color circles may denote wildlife breeding data found within the project area. Content editors, or others, may adjust configuration settings to present the most critical information on the dashboard 11, with additional information accessible by selecting one or more system tabs 51 at the top of the dashboard 11. By selecting or clicking on the document highlighted on the dashboard, the system will allow the user to open the field survey record 59, or other documents from the document management system 43, for example, as shown in FIG. 15.

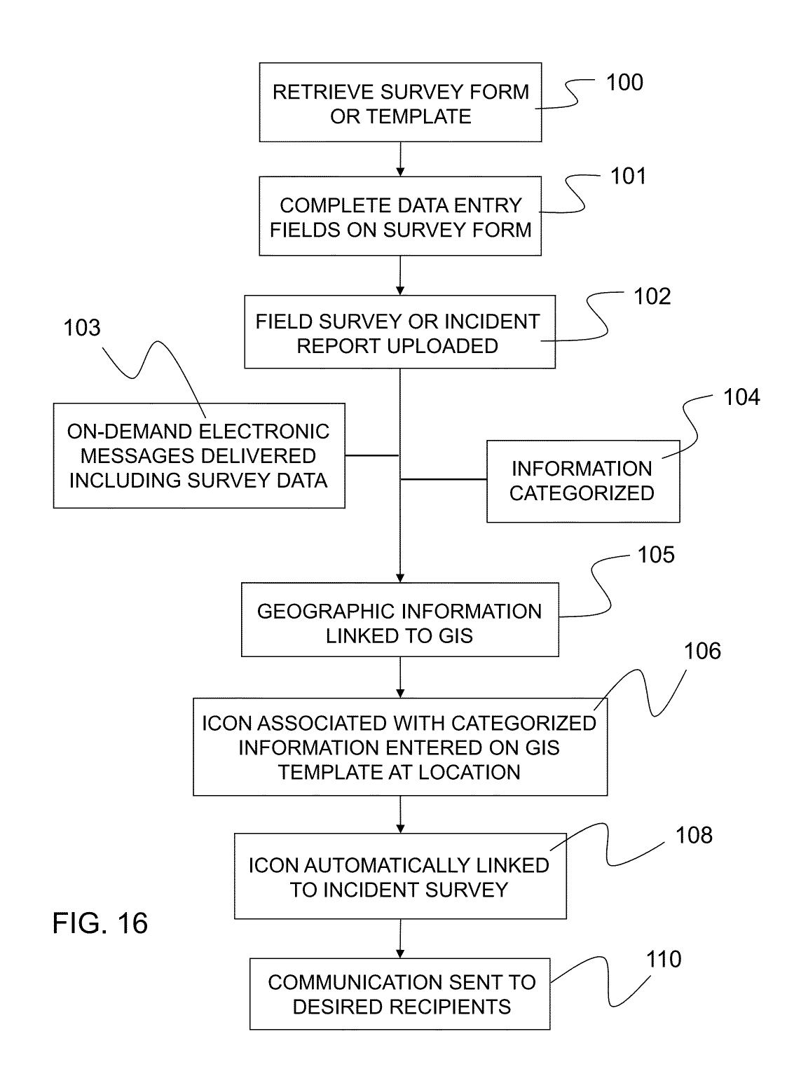

The integration of the field data, for example incidental and attribute data from the incidental surveys with the GIS as described above is an important aspect of the present invention because it directly visually associates any and all collected field data with a geographical location relative to the project. In one embodiment of the present invention shown in FIG. 16, an ECS user can retrieve a predefined survey form or template at step 100, complete the required data fields at step 101, and the survey form and data can then be uploaded to an appropriate database at step 102. The information and data may be disseminated through the on-demand email notification system at step 103. The data may also be categorized by the underlying ECS program at step 104 and the geographic location information from the incidental observation survey is linked to the GIS at step 105. The ECS associates an icon in the GIS at step 106 with the appropriately categorized information and the incidental observation survey on a GIS template for display of the icon at the appropriate geographic location in the GIS. At step 108, the icon is linked to the relevant incidental observation survey for display of at least part of the survey when the icon is selected by the user. A communication or alert may be sent to appropriate parties at step 110 in order to update and inform the parties to the updated GIS and other underlying survey data.

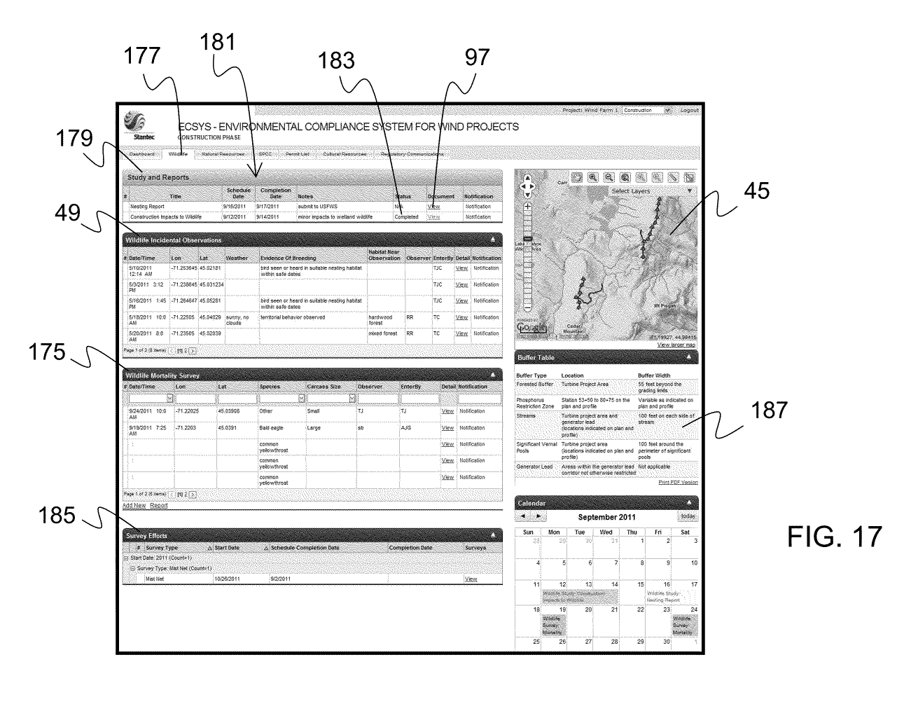

Database tabs 51 may be configured by the system administrator to display database information particularly associated with the requirements of a particular phase of the project. For example, access to information on environmental impact, permits and regulatory information may be more important for users during the construction phase and therefore the ECS for this phase can be configured in this manner. A wildlife tab 177 as shown in FIG. 17 provides access to all completed, on-going and pending wildlife studies. The study and report table 179 may provide a list of all studies and reports with schedule and completion data 181, a status of completion 183 and a view option 97 to access the study or report documents. The incidental observation table 49 and wildlife mortality survey table 175 display all observations made in general or during the course of one or more studies completed over each phase of the project. Each survey record including such observations and incidents is displayed on the GIS 45 as a color coded icon identifying the type of observation recorded. A breakdown of the start and completed times of surveys conducted is shown in the survey efforts table 185 providing information on the amount of time for survey completion and reports on numbers of personnel working on the survey and the amount of area covered. The buffer table 187 provides boundary distances around features of the facility, wildlife areas, wetlands and other natural and man made formations to properly denote restricted, limited access or high risk areas.

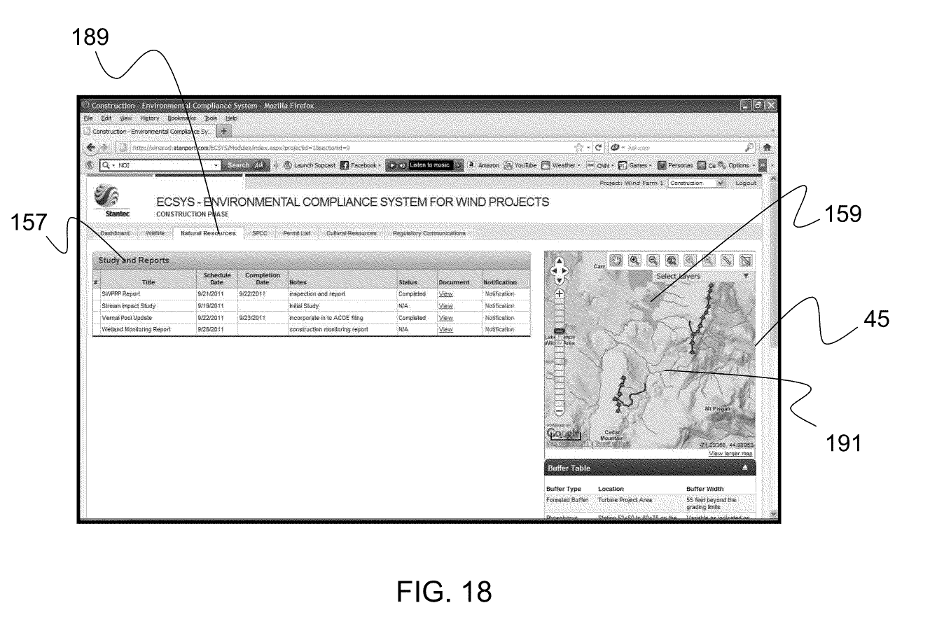

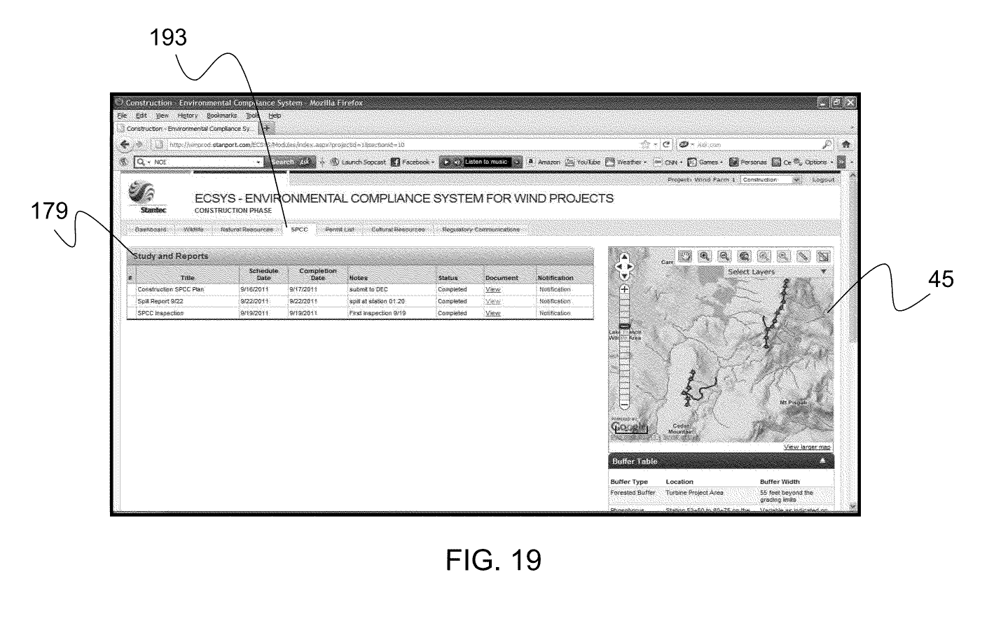

A natural resources tab 189 and grid 157 as shown in FIG. 18 may display studies and investigations on the current status of waterways and other geographical features within and surrounding the project area. A studies and reports grid 179 may include, for example, Storm Water Pollution Prevention Plan (SWPPP) reports and/or impact studies on the effect of the project and operating facility on wetlands and waterways. Wetlands, waterways 191 and other geographical information may be displayed on the GIS 45 with icons or overlays denoting specific areas of study. An SPCC tab 193 as shown in FIG. 19 may be displayed that includes a study and reports grid 179 that has pending, on-going and completed inspection and construction reports related to spill prevention and control. By providing access to all necessary and historical data on construction information, inspection times and study reports among facility personnel, safety personnel and regulatory authorities, both reaction time and taking of appropriate measures to control and contain spills or other events may be significantly improved. Importantly, records of the logged event will be easily stored and retrieved in the ECS for regulatory audits, analysis, etc. Location information of spill areas may also be shown on the GIS 45 for example as a cover overlay to better track and assist with provision of supporting compliance evidence.

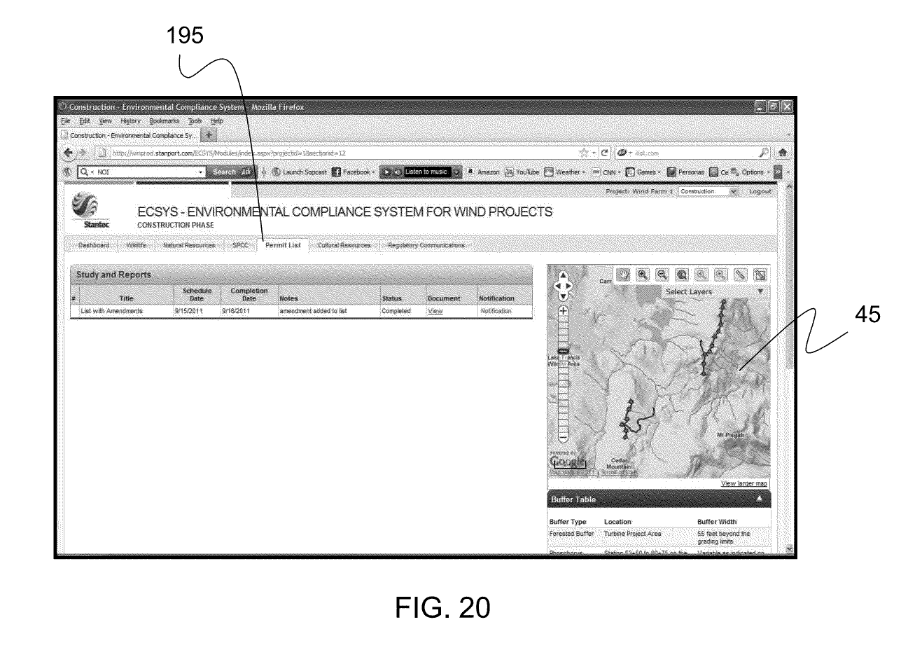

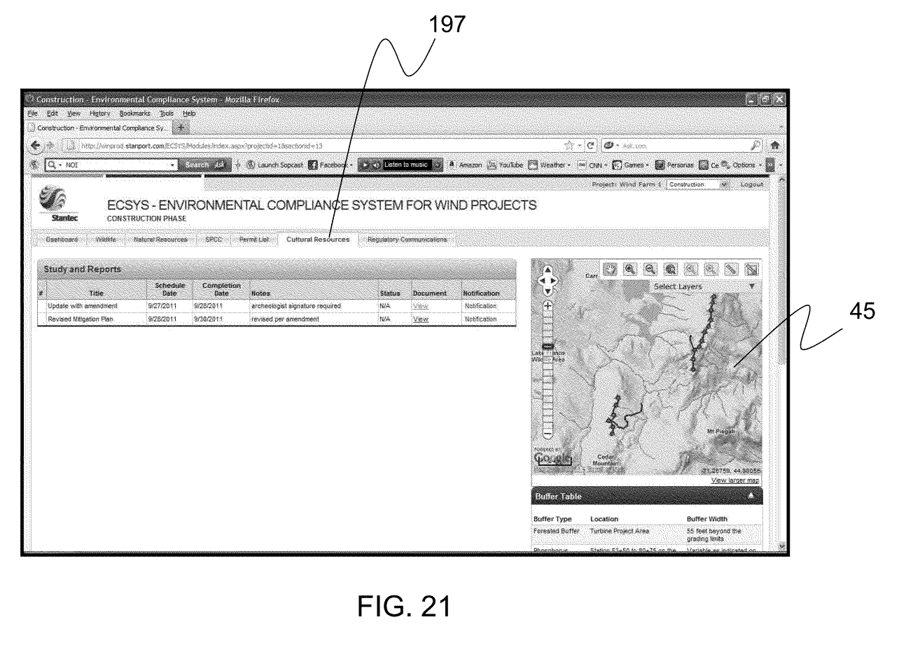

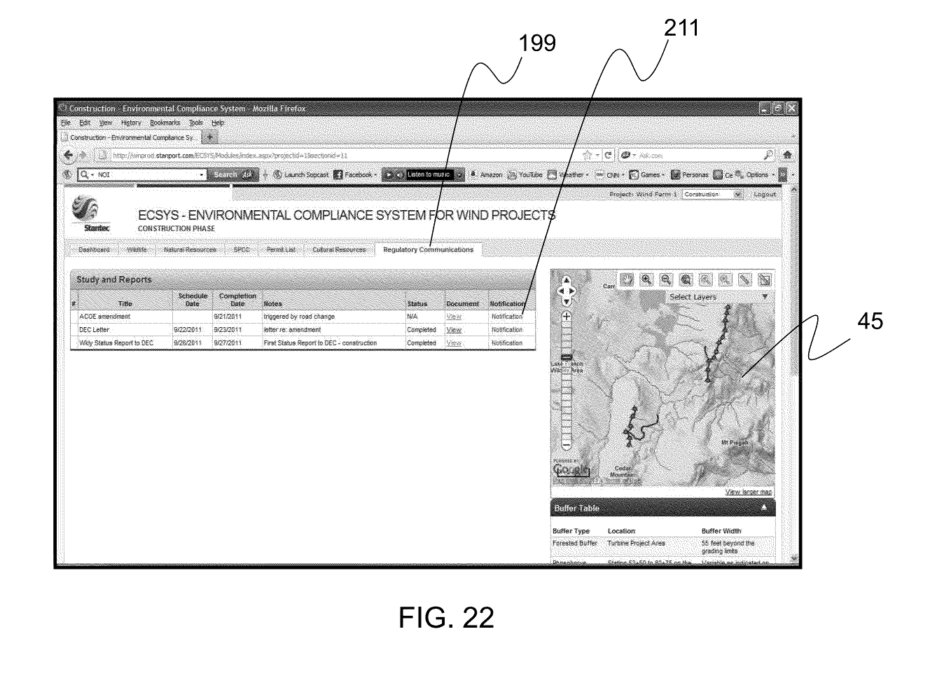

A permit tab 195 shown in FIG. 20 may provide information on all required permits for all phases, or specific phases, of the project. A cultural resource tab 197 as shown in FIG. 21 may provide data, information and reports on archeological assessments of the project area. Archeological discoveries or areas of interest may also be displayed on the GIS 45. Importantly, the regulatory communications tab 199 shown in FIG. 22 can provide access to all data, information and reports issued by the regulatory authority with notification to all responsible and effected parties, allowing for construction plan amendments and modifications to be made and implemented as needed reducing delays and overall construction costs.

Data entered from, for example, a field survey 59 can trigger the email notification generator 61 that inserts, links or associates the entered data to one or more electronic messages in one or more formats, for example email, tweet, text or other known or future known message formats, to accommodate different communication devices accessible to a network, such as the internet 14. For example, the notification email to specific users stating pertinent information that a regulatory report has been uploaded to the ECS. Alternatively, a more complete message such as information on the data entered, such as the species of a dead bird found during a wildlife mortality survey 175 may also be created including all or any portion of the entered survey data.

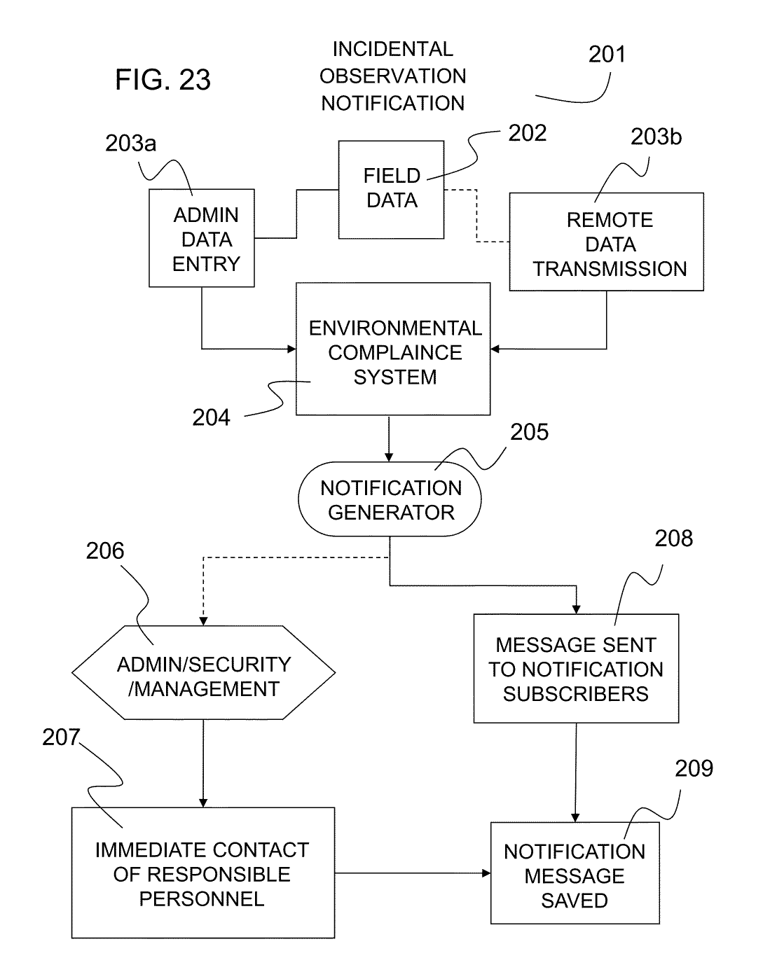

An embodiment of a flowchart of the on-demand messaging and notification system 201 of the ECS is shown in FIG. 23. The field survey data 202 can be entered in a number of ways, such as by an administrator at step 203a or automatically using a remote data transmission device at step 203b and uploaded to the ECS at step 204. The data 202 triggers the notification generator to insert, link or associate the data to a formatted electronic message at step 205. The email notification may, in some instanced, only send a message that the data is available, accessible or pertinent for example. Alternatively the email notification may be forwarded directly to selected and predetermined ECS users or subscribers at step 208 and, depending on the permission levels of the users, specific personnel may also receive the notification. The electronic message may be forwarded to one or more security administrators or management personnel at step 206 where it is reviewed. The person posting the data, or a security administrator, determines if specific project management personnel, safety personnel or other appropriate parties must be contacted immediately at step 207 to respond to the reported event. In either or both events the notifications of subscribers or other parties are saved at step 209 in the ECS along with the specific incidental observation and survey data in the database for future regulatory or other auditing procedures.

The email notification system can be further integrated with the ECS system calendar to provide notifications to subscribers of any scheduled upcoming event or deadline. Members of the subscription notification list are configured by system administrators based upon user preferences and responsibilities. Also based on user preferences, the email notification system may also be an electronic message system appropriately formatting the notification for email servers for users of personal computers, laptops, PDA, iPod, iPad or other handheld devices using wireless, Bluetooth or other technologies to receive communications. In addition to the message information, the email may also include a link to the login screen of the ECS and upon entering the system provide access to further information on the message such as the geographical information and survey data of the observed incident. The system may also add appropriate encryption based, in part, on what is being sent and to whom it is being sent.

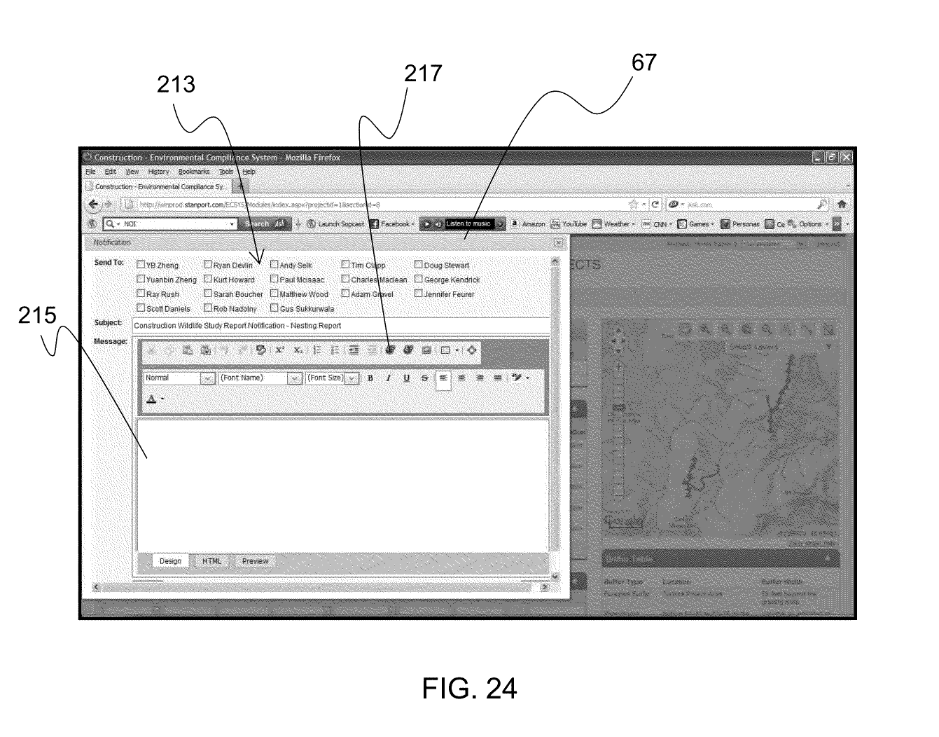

Distribution to users using the set notification subscription lists is an instantaneous method of sending notifications and perhaps data to appropriate users as quickly as possible. Additionally, information from any report, incidental observation or study may be forwarded to one or more individuals by selecting the notification option 211 from any study or report screen within the ECS. As shown in FIG. 24, the email notification system 67 provides a list of all subscribers 213 or others, a comment dialog box 215 and a link option 217 to attach the report or incidental observation to the electronic message. Other formatting options to format the message text are available. In this way a report reviewer can comment and distribute notes, recommendations and commands to the appropriate personnel to quickly and efficiently address safety compliance and/or regulatory issues thereby preventing or limiting delays or shutdowns and reducing the overall Project costs.

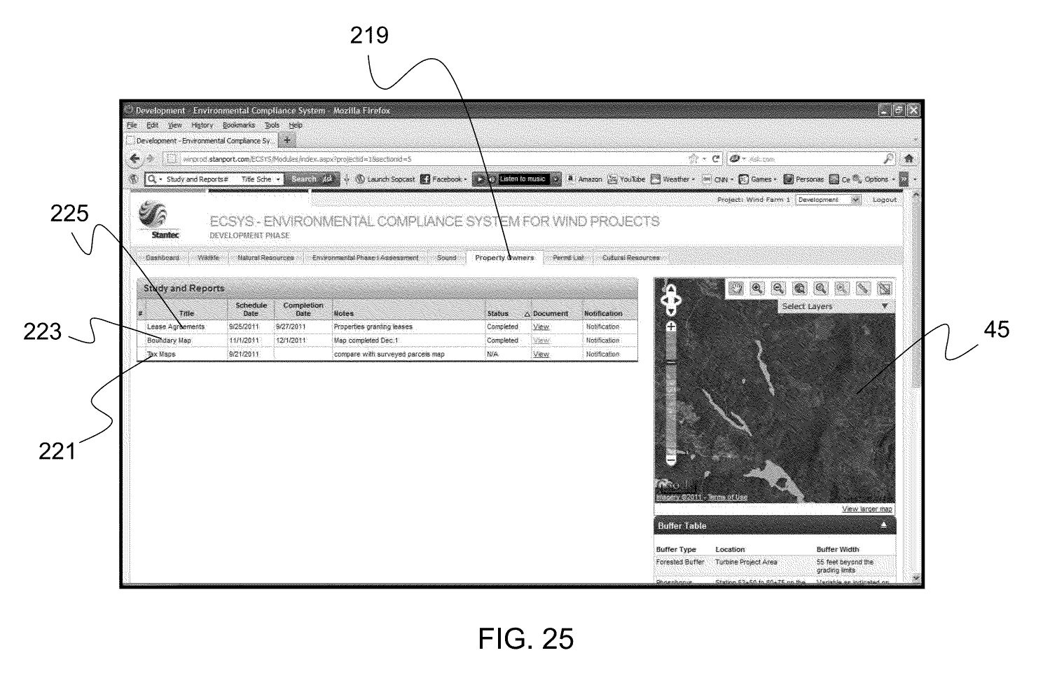

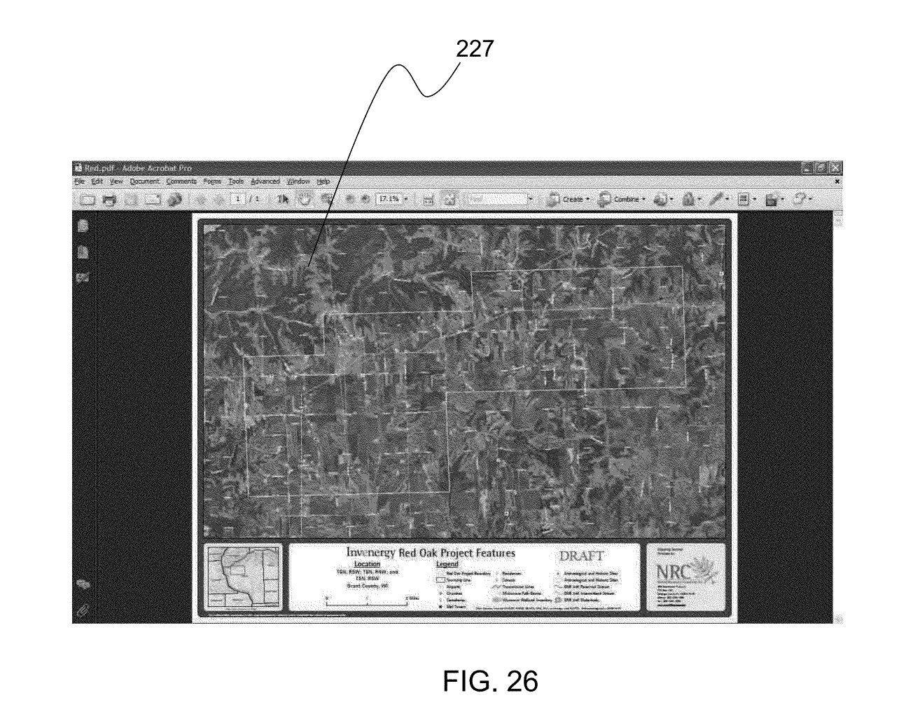

In the development phase there are many pieces of critical information needed to determine the best location for a utility plant or facility. As an example, a client of the system may have interest in establishing a wind turbine within a specific geographic area. To determine the most appropriate area for installation there are a number of factors within a broad scope of environmental conditions, lease and/or ownership of land and regulatory requirements. The ECS can assist the client through all steps of decision making during the development process and assist throughout in managing and meeting requirements during the construction, operational and decommissioning phases of the project saving time and money in all facets of the project. A first consideration might be, for example, access to land that may be acceptable as a facility site globally. A key factor is determination of ownership of land for the site and for all land surrounding the site where access roads and transmission lines must be built and maintained. As shown in FIG. 25 a property owners tab 219 may provide a tax map 221 of all property owners within the region, a boundary map 223 of all property that abuts the utility company's planned facility sight, a summary of all lease agreements 225 as well as other pertinent ownership and transaction information of the surrounding area. Boundaries and ownership information may be displayed on the GIS 45 based upon data from registered deeds, town planning documents and other data. Information is easily accessed by using the GIS 45 and scrolling through each designated plot to display the owner, land area and geographic boundaries of the property to determine the most viable routes for transmission lines, access roads, and facility construction sites. Information may also be accessed by selecting and highlighting for example the boundary map from the study and reports table to update the GIS 45 to include this information as described above. Additional, town plots zoning and regulatory maps 227 as shown in FIG. 26 may be viewed by selecting the view option. The organizational and integrated linkages of data in the ECS provide multiple users with this type of information within one system allowing users to share thoughts, to better understand the complex inter-relationships of data, and to track project revisions in real time.

The invention has been described in detail with particular reference to certain preferred embodiments thereof, but it will be understood that variations and modifications can be effected within the spirit and scope of the invention.

What is claimed is:

1. An environmental compliance and communications system streamlining environmental regulation compliance for any phase of a project including development, construction and/or operation, the compliance and communications system comprising:
an administrator function for maintaining operating system application software installed on a secure server connected to a network interface and applying user access controls for a system user with modifiable access rights to at least one of view, enter and modify data in the compliance and communications system, the application software comprising;
one or more databases including environmental regulatory requirement data for tracking by the compliance and communications system and a visual key performance checklist which displays at least one of a desired textual or graphical representation of the environmental regulatory requirement data and a status of the project compliance with the regulatory requirement data, the one or more databases further including compiled environmental data corresponding to and developed relative to the environmental regulatory requirement data;
a visually displayed timeline separate from the key performance checklist and accessing data from the at least one database including at least one of visual daily, monthly and annual displays associating desired environmental regulatory requirement event data with a particular date;
a documentation library display table providing access to at least one of documents, studies and reports including certain the compiled environmental data; and
a geographical information system providing visual geographic map location information corresponding to data from the one or more databases.

2. The environmental compliance system of claim 1 further comprising a communication system for automatically forwarding desired data from the one or more databases to system users and administrators.

3. The environmental compliance system of claim 2 further comprising a field observation data entry node facilitating remote data upload to the environmental compliance system from the project field environment.

4. The environmental compliance system of claim 3 further comprising the remote data upload incorporated into the one or more databases as incidental observation data wherein at least a portion of the incidental observation data is visually displayed in an incidental observation table to the user.

5. The environmental compliance system of claim 4 further comprising the incidental observation data being integrated and visually displayed to the user in at least one of the geographical information system, the timeline, the key performance checklist and the documentation library.

6. The environmental compliance system of claim 5 wherein an electronic communication of incidental observation data is automatically distributed to users through the communication system.

7. The environmental compliance system of claim 6 wherein the electronic communication of incidental observation data is automatically distributed to users through the communication system within a predetermined time period.

8. The environmental compliance system of claim 4 further comprising incidental observation data being associated with a data representative icon and the icon being displayed to the user in the geographical information system in the visual geographic map location corresponding to geographic location data uploaded with the incidental observation data.

9. The environmental compliance system of claim 1 wherein at least the geographical information system, the timeline, the key performance checklist and the documentation library are provided on a single viewable graphical user interface to the user.

10. The environmental compliance system of claim 8 wherein the data representative icon displayed in the geographical information system is linked to at least one of the documents, studies and reports represented in the documentation library display table.

11. The environmental compliance system of claim 1 wherein the geographical information system further comprises relative measurement and visual display of at least one of an area and a distance within the geographical display.

12. The environmental compliance system of claim 1 wherein the visual key performance checklist comprises visual graphical status indicators representative of compliance status including pending, completed and out-of-compliance indicators.

13. A data distribution network for providing information to network users regarding project regulatory compliance, the data distribution network comprising;
at least one software program installed on a computer within the network;
at least a first database accessible by the software program;
a graphical user interface for displaying and enabling a user to monitor and access data from the first database; and
a remote data upload template permitting remote field data entry including at least one of geographical data and location coordinates into the at least one database, and
a geographic information system in the graphical user interface visually displaying an associated reference icon linked to the field data entry on a map at a map location corresponding to the at least one of geographical location data and location coordinates from the remote field data entry.

14. A method of providing environmental compliance and communications for streamlining environmental regulation compliance for any phase of a project including development, construction and operation, the method comprising the steps of:
maintaining operating system application software installed on a secure server connected to a network interface and applying user access controls for a system user with modifiable access rights to at least one of view, enter and modify data;
providing one or more databases including environmental regulatory requirement data for tracking environmental compliance and communication linked to a visual key performance checklist displaying at least one of a desired textual or graphical representation of the environmental regulatory requirement data and a status of the project compliance with regulatory requirement and data including compiled environmental data corresponding to and developed relative to the environmental regulatory requirement data;
visually displaying a timeline separate from the key performance checklist and accessing data from the at least one database including at least one of visual daily, monthly and annual displays associating desired environmental regulatory requirement event data with a particular date;
displaying a documentation library table providing access to at least one of documents, studies and reports including certain compiled environmental data; and
displaying a geographical information system providing visual geographic map location information corresponding to data from the one or more databases.

15. The method of providing environmental compliance and communications as set forth in claim 14 further comprising the step of automatically forwarding desired data in the at least one database to system users and administrators via an electronic messaging system.

16. The method of providing environmental compliance and communications as set forth in claim 14 further comprising the step of providing a field observation data entry node facilitating remote data upload to the environmental compliance system from the project field environment.

17. The method of providing environmental compliance and communications as set forth in claim 16 further comprising the step of incorporating the remote data upload into the one or more databases as incidental observation data wherein at least a portion of the incidental observation data is visually displayed in an incidental observation table to the user.

18. The method of providing environmental compliance and communications as set forth in claim 17 further comprising the step of the incidental observation data being integrated and visually displayed to the user in at least one of the geographical information system, the timeline, the key performance checklist and the documentation library.

19. The method of providing environmental compliance and communications as set forth in claim 17 further comprising the step of automatically sending an electronic communication of incidental observation data to predetermined recipients.

20. The method of providing environmental compliance and communications as set forth in claim 17 further comprising the step of associating incidental observation data with a data representative icon and the icon being displayed to the user in the geographical information system in the visual geographic map location corresponding to geographic location data uploaded with the incidental observation data.
